(19) United States
(12) Patent Application Publication
(10) Pub. No.: US 2020/0377716 A1
(43) Pub. Date: Dec. 3, 2020

(54) HOT MELT COMPOSITIONS INCLUDING STYRENE BLOCK COPOLYMER AND WAX

(71) Applicant: H.B. Fuller Company, St. Paul, MN (US)

(72) Inventors: Thomas F. Kauffman, Woodbury, MN (US); Yiming Zeng, Minneapolis, MN (US)

(21) Appl. No.: 16/887,357

(22) Filed: May 29, 2020

Related U.S. Application Data
(60) Provisional application No. 62/855,347, filed on May 31, 2019.

(51) Int. Cl. C08L 53/02; C08L 91/06; B32B 5/02; B32B 5/24; B32B 27/06; B32B 27/12; B32B 7/12

(52) U.S. Cl. CPC C08L 53/02; C08L 91/06; B32B 5/022; B32B 5/24; B32B 27/06; B32B 2305/30; B32B 7/12; C08L 2205/035; B32B 2535/00; B32B 2262/0253; B32B 2264/0214; B32B 27/12

(57) ABSTRACT

The hot melt compositions of this invention include from 15% by weight to 60% by weight of a styrene block copolymer, from 15% to 75% by weight of a wax having a Congealing Point (ASTM D938) of from 45° C. to 90° C. and optionally a propylene based polymer. The hot melt composition can be free of both tackifying agent and plasticizer and is useful in a variety of hygiene applications.

This application claims priority to and benefit of U.S. Provisional Patent Application No. 62/855,347 filed on May 31, 2019.

### BACKGROUND

Hot melt compositions are often used to bond substrates together so as to maintain the two substrates in a fixed relation to each other or to contribute to the integrity and functionality of the finished article. In the area of industrial adhesives, hot melt compositions are commonly used to bond together or to contribute to the integrity and functionality of a wide variety of articles including packaging materials (e.g. cases and cartons), disposable absorbent articles comprising non-woven substrates e.g. adult incontinence products, disposable diapers, sanitary napkins, bed pads, puppy pads, medical dressings, etc.

There can be multiple hot melt compositions used in the manufacture of a disposable absorbent article. For example, in the manufacture of a disposable diaper, hot melt compositions are used as construction adhesive (e.g. bonding the back sheet to the nonwoven and optionally the absorbent pad), as elastic attachment adhesives (e.g. bonding the elastic material to the back sheet in for example the leg or waist area), for core stabilization (e.g. applying a hot melt composition to the absorbent core to increase the strength of the core) and as an elastic material to provide stretch properties to the disposable absorbent article.

There is a need for alternative hot melt compositions that can exhibit good elongation, strength and adhesion, while exhibiting low odor, superior heat stability and being free of certain compounds found in plasticizers.

### SUMMARY

In one aspect, the invention features a hot melt composition including 15% by weight to 60% by weight of a styrene block copolymer, 15% by weight to 75% by weight of a wax having a Congealing Point (ASTM D938) of from 45° C. to 90° C., and no greater than 10% by weight of a liquid plasticizer.

In one embodiment, the hot melt composition is free of liquid plasticizer. In another embodiment, the hot melt composition includes a total polymer content of from 15% by weight to 45% by weight. In one embodiment, the hot melt composition includes from 25% by weight to 75% by weight of the wax.

In a different embodiment, the hot melt composition additionally includes 5% by weight to 40% by weight of a propylene based polymer. The propylene based polymer can be derived from propylene and at least one monomer selected from the group consisting of hexene, butene, and ethylene. In another embodiment, the propylene based polymer has a viscosity at 190° C. by ASTM D3236 of no greater than 7,500 cP.

In one embodiment, the wax is a paraffin wax. In another embodiment, the styrene block copolymer has a hydrogenated mid-block. In one embodiment, the styrene block copolymer is a styrene-isoprene-styrene block copolymer. In a different embodiment, the styrene block copolymer has a melt flow index ASTM D1238 (230° C., 2.16 kg) of from 10 to 300.

In another embodiment, hot melt composition further includes from 5% by weight to 40% by weight of a tackifying agent. In still another embodiment, the hot melt composition is free of a tackifying agent.

In one embodiment, the hot melt composition has an elongation of greater than 800%. In a different embodiment, the hot melt composition has an elongation of greater than 600% and a maximum tensile stress of at least 1.5 megapascals.

In another aspect, the invention features a hot melt composition including from 15% by weight to 45% by weight of a styrene block copolymer, from 35% by weight to 75% by weight of a wax having a Congealing Point (ASTM D938) of from 45° C. to 90° C., and optionally up to 40% by weight of a tackifying agent, wherein the hot melt composition is free of plasticizer.

In a different aspect, the invention features an absorbent article including a hot melt composition and a core comprising the hot melt composition and absorbent material; wherein the hot melt composition secures at least a portion of the absorbent core to a material of the absorbent article; and wherein the hot melt composition includes from 15% by weight to 45% by weight of a styrene block copolymer, and from 25% by weight to 75% by weight of a wax having a Congealing Point (ASTM D938) of from 45° C. to 90° C.

In one embodiment, the core comprises no more than 10% by weight fluff. In another embodiment, the hot melt composition comprises a total polymer content of no greater than 47% by weight. In a different embodiment, the wax is a paraffin wax. In still another embodiment, the styrene block copolymer is a styrene-isoprene-styrene block copolymer.

The hot melt compositions of this invention have superior elongation and can have adhesive properties in the absence of or with a limited amount of tackifying agent. In compositions with no or limited tackifying agent, it is important to find a different way to reduce viscosity while maintaining high elongation and further to introduce cohesion or stiffness into the hot melt composition. In the compositions of this invention, the wax is useful in this regard.

The inventors unexpectedly discovered that the addition of wax can enhance the elongation and maintain the maximum tensile stress of the claimed compositions while reducing their viscosity. It is further unexpected that the use of high amounts of wax can result in a better balance of desired properties as compared to traditional liquid plasticizers.

The hot melt compositions of this invention can be free of plasticizer. This is desirable as plasticizers can cause staining and often contain volatile materials or poly aromatic hydrocarbons (PAHs) that are undesirable to the end user.

The hot melt compositions of this invention are particularly useful for core stabilization. In core stabilization, the hot melt composition, often in the form of a fiberized structure can be used to keep the absorbent material of the core in place.

The inventors also envision that the hot melt compositions of this invention could be useful as a construction adhesive or as an elastic material to provide stretch in a disposable absorbent article.

Other features and advantages will be apparent from the following description of the preferred embodiments and from the claims.

### Glossary

Fluff—cellulosic fibers

Entirely fluff free—an absorbent core that contains no fluff

Propylene based—comprising at least 50% by weight propylene.

### DETAILED DESCRIPTION

### Hot Melt Composition

The hot melt composition includes from 15% by weight to 60% by weight of a styrene block copolymer and from 15% to 75% by weight of a wax having a Congealing Point (ASTM D938) of from 45° C. to 90° C.

The hot melt composition can include no greater than 40% by weight, no greater than 30% by weight, no greater than 20% by weight, no greater than 10% by weight or is even free of tackifying agent. The hot melt composition can further include no greater than 10% by weight, no greater than 5% by weight, or is even free of plasticizer. The hot melt composition can be free of both tackifying agent and plasticizer.

The styrene block copolymer, the propylene based polymer and the wax can make up at least 85% by weight, at least 90% by weight or even at least 95% by weight of the hot melt composition.

Alternatively, the styrene block copolymer, the tackifying agent and the wax can make up at least 85% by weight, at least 90% by weight or even at least 95% by weight of the hot melt composition.

In one embodiment, the styrene block copolymer is a styrene isoprene styrene block copolymer and the wax is a paraffin wax.

In another embodiment, the hot melt composition includes from 15% by weight to 45% by weight of the styrene block copolymer, from 35% by weight to 75% by weight of the wax and optionally up to 30% by weight, or even up to 40% by weight of a tackifying agent.

The viscosity of the hot melt composition can be no greater than 20,000 cP at 162.8° C., no greater than 15,000 cP at 162.8° C., between about 500 cP and 20,000 cP at 162.8° C., or even between about 500 cP and 10,000 cP at 162.8° C.

The hot melt composition can have an elongation of greater than 600%, greater than 800%, greater than 900%, greater than 1000%, from 600% to 1500% or even from 800% to 2000%.

The hot melt composition can have a maximum tensile stress of at least 1.0 megapascals (mpa), at least 1.5 mpa, at least 2.0 mpa, from 1.0 mpa to 10 mpa, or even from 1.5 mpa to 8 mpa.

When used for core stabilization, a high elongation allows the hot melt composition to stretch with the absorbent core, while having a threshold maximum tensile stress allows the hot melt composition to hold the core firmly in place when the disposable absorbent article is in use.

The hot melt composition can have a dynamic peel of at least 15 grams force (gf) inch, at least 30 gf/inch, at least 50 gf/inch, from 15 gf/inch to 200 gf/inch, from 30 gf/inch to 150 gf/inch, from 30 gf/inch to 250 gf/inch or even from 60 gf/inch to 250 gf/inch.

The hot melt composition can have a maximum tensile stress of from 1.0 to 10 mpa and an elongation of from 600% to 3000%, or even 800% to 2500%.

Polymer

The hot melt composition can have a total polymer content of from 15% by weight to 70% by weight, or even from 20% by weight to 60% by weight.

Alternatively, it can be useful to limit the polymer content to less than 50% by weight to allow for the presence of more wax and optionally tackifying agent. The total polymer content can be no greater than 47% by weight, no greater than 45% by weight, from 20% by weight to 47% by weight, or even from 15% by weight to 45% by weight.

The hot melt composition includes a styrene block copolymer and can optionally include additional polymers such as e.g. propylene based polymers.

Styrene Block Copolymer

The hot melt composition includes a styrene block copolymer.

The styrene block copolymer includes an aromatic vinyl polymer block and a conjugated diene polymer block, a hydrogenated conjugated diene polymer block, or a combination thereof. The blocks can be arranged in a variety of configurations including, e.g., linear, branched, radial, star, tapered, multi-block and combinations thereof. The aromatic vinyl polymer block can be derived from a variety of aromatic vinyl compounds including, e.g., styrene, alpha-methylstyrene, beta-methylstyrene, o-, m-, p-methylstyrene, t-butylstyrene, 2,4,6-trimethylstyrene, monofluorostyrene, difluorostyrene, monochlorostyrene, dichlorostyrene, methoxystyrene, 1,3-vinylnaphthalene, vinylanthracene, indene, acenaphthylene, and combinations thereof. The diene polymer block can be derived from a variety of diene-containing compounds including, e.g., isoprene, butadiene, hexadiene, 2,3-dimethyl-1,3-butadiene, 1,3-pentadiene, and hydrogenated versions thereof, and combinations thereof.

Useful styrene block copolymers include, e.g., triblock, multi-arm and radial copolymers including, e.g., styrene-butadiene-styrene (SBS), styrene-isoprene-styrene (SIS), styrene-butadiene-isobutylene-styrene (SBBS), styrene-isoprene-butadiene-styrene (SIBS), styrene-ethylene/butene-styrene (SEBS), styrene-ethylene/propylene-styrene (SEPS), styrene-ethylene-ethylene/propylene-styrene (SEEPS), styrene-ethylene/butene/styrene-styrene (SEBSS) and combinations thereof.

The styrene block copolymer can have a styrene content of at least 10% by weight, at least 12% by weight, no greater than 50% by weight, no greater than 40% by weight, no greater than 35% by weight, from 10% by weight to 50% by weight, from 12% by weight to 45% by weight, from 12% by weight to 25% by weight, or even from 20% by weight to 45% by weight.

The styrene block copolymer can have a melt flow rate ASTM D1238 (230° C., 2.16 kg) of from 2 to 300, from 10 to 300, or even from 15 to 250.

The styrene block copolymer can have an unsaturated mid-block, alternately the mid-block can be saturated i.e. hydrogenated. In a preferred embodiment, the mid-block is saturated to lower the odor, improve the heat stability and improve the compatibility of the hot melt composition. The styrene block copolymer can be selected from the group consisting SEBS, SEPS, SEEPS and SEBSS. The styrene block copolymer can be a blend of one or more styrene block copolymers.

Alternatively, the styrene block copolymer can be a styrene isoprene styrene block copolymer to improve adhesion and lower cost.

The styrene block copolymer can be the only polymer present in the hot melt composition. The styrene block copolymer can be present in the hot melt composition at, at least 20% by weight, at least 25% by weight, from 25% by weight to 70% by weight, from 28% by weight to 65% by weight, from 15% by weight to 60% by weight, from 25% by weight to 45% by weight, or even from 15% by weight to 40% by weight.

Useful styrene block copolymers are available under a variety of trade designations including, e.g., KRATON G 1657, KRATON G 1643, KRATON MD 1648 and KRATON MD6951 which are available from Kraton Polymers U.S. LLC (Houston, Tex.); DPX-660, VECTOR 4111, VECTOR 4114, VECTOR 4211 and VECTOR 4411 which are available from TSRC Corporation (Taipei City, Taiwan); EUROPRENE SOL 1205 and SOL TH 2311 which are available from Versalis SpA (Milan, Italy); and GLOBALPRENE 3566 which is available from LCY Elastomers LP (Baytown, Tex.).

Propylene Based Polymer

The hot melt composition optionally includes a propylene based polymer.

If the hot melt composition is expected to adhere two substrates together, the composition preferably includes a propylene based polymer. The propylene based polymer can be a homopolymer. Alternatively, the propylene based polymer is derived from propylene and at least one olefin comonomer other than propylene. In a preferred embodiment, the propylene based polymer is derived from propylene and at least one monomer selected from the group consisting of ethylene, butene and hexene. The alpha-olefin can be a propylene butene copolymer.

Useful propylene based polymers can exhibit a heat of fusion of no greater than 40 Joules/gram (J/g), no greater than 20 J/g, no greater than 14 J/g, no greater than 12 J/g, no greater than 10 J/g, from 0 to 40 J/g, or even from 0 to 20 J/g.

The propylene based polymer exhibits a viscosity of no greater than 10,000 cP, no greater than 7,500 cP, no greater than 5,000 cP, from 250 cP to 10,000 cP, or even from 500 cP to 7500 cP at 190° C.

Useful propylene based polymers include, e.g., copolymers, terpolymers, higher order polymers, and combinations thereof, and are derived from propylene and at least one alpha-olefin comonomer other than propylene including, e.g., alpha-olefin monomers having at least two carbon atoms, at least four carbon atoms, from four carbon atoms to eight carbon atoms, and combinations thereof. The propylene based polymer optionally includes a blend of at least two different alpha-olefins. Useful alpha-olefin monomers include, e.g., ethylene, butene, pentene, hexene, heptene, octene, nonene, decene, dodecene, 4-methyl-1-pentene, 3-methyl-1-pentene, 3,5,5-trimethyl-1-hexene, 5-ethyl-1-nonene, and combinations thereof. Suitable alpha-olefin comonomers also include mono-alpha olefins (i.e., one unsaturated double bond) and higher order olefins.

The propylene based polymer preferably is free of functional groups but optionally includes functional groups.

The propylene based polymer can be prepared using a non-single site catalyst (e.g., a Ziegler Natta catalyst) or a single-site (e.g. metallocene) catalyst.

The hot melt composition optionally includes from 5% by weight to 40% by weight, or even from 10% by weight to 35% by weight of a propylene based polymer.

Useful propylene based polymers are commercially available under a variety of trade designations including, e.g., REXTAC 2715 and 2730 propylene-butene copolymers from Rextac, LLC (Odessa, Tex.); VESTOPLAST V2094 and V 2103 ethylene-propylene-butene terpolymers from Evonik Resource Efficiency GmbH (Essen, Germany). AERAFIN 180 and AERAFIN 17 propylene-ethylene copolymers from Eastman Chemical Company (Kingsport, Tenn.) and VISTAMAXX 8380 and VISTAMAXX 8780 propylene-ethylene copolymers from ExxonMobil Chemical Company (Houston, Tex.).

Wax

The hot melt composition includes a significant amount of wax.

Useful classes of wax include, e.g., paraffin waxes, microcrystalline waxes, Fischer-Tropsch waxes, oxidized Fischer-Tropsch waxes, animal waxes, vegetable waxes (e.g. soy wax) and combinations thereof. The wax can be functionalized.

Useful waxes are solid at room temperature and preferably have a Congealing Point (ASTM D938) of from 45° C. to 90° C., from 50° C. to 85° C., or even from 55° C. to 75° C.

The hot melt composition can include from 15% by weight to 75% by weight, from 15% by weight to 65% by weight, from 20% by weight to 65% by weight, from 22% by weight to 62% by weight, from 25% by weight to 75% by weight, from 30% by weight to 75% by weight, from 35% by weight to 75% by weight, or even from 40% by weight to 75% by weight of a wax.

The wax can include one or more waxes.

Useful commercially available paraffin waxes include e.g., FR-6513 from Citgo Petroleum (Houston, Tex.), SASOLWAX 6705 from Sasol Performance Chemicals (Hamburg, Germany) and IGI 1240 from The International Group, Inc. (Toronto, Ontario). Useful commercially available Fischer-Tropsch waxes include SARAWAX SX-70 and SX-80, Fischer-Tropsch waxes from Shell MDS (Bintulu, Malaysia) and SASOLWAX C-80, Fischer-Tropsch wax from Sasol Performance Chemicals (Hamburg, Germany).

Plasticizer

The hot melt composition is free of plasticizer or can optionally include a limited amount of plasticizer. The plasticizer can be selected from the group consisting of polybutene and polyisobuylene.

The hot melt composition comprises no greater than 15% by weight, no greater than 10% by weight, no greater than 5% by weight, or even is free of plasticizer.

In another embodiment, the hot melt adhesive composition comprises no greater than 15% by weight, no greater than 10% by weight, no greater than 5% by weight, or even is free of oil.

Useful plasticizers include, e.g., polybutene, polyisobutylene, polyolefin copolymers (e.g., propylene-ethylene copolymers), oligomerized alpha olefins, oils (e.g., naphthenic petroleum-based oils, paraffinic oils, mineral oils, animal oils, vegetable oils, synthetic oils, derivatives of oils, liquid isoprene, glycerol esters of fatty acids, and combinations thereof), and combinations thereof.

Useful plasticizers are commercially available under a variety of trade designations including, e.g., the INDOPOL series of trade designations from Ineos Oligomers Europe, Limited (Belgium) including INDOPOL H-300, H-1200, H-1500, H-1900, and H-2100 polybutenes, the DURASYN series of trade designations from Ineos Oligomers Europe including DURASYN 127 poly-1-decene, the TPC series of trade designations from TPC Group (Houston Tex.) including TPC 5230, TPC1105, TPC1160, TPC1285 and TPC1350 polyisobutylenes, the LICOCENE series of trade designations from including, e.g., LICOCENE PPA 330 TP propylene-ethylene copolymer, KAYDOL mineral oil from Sonneborn (Tarrytown N.Y.), KRYSTOL 550 mineral oil from Petrochem Carless Limited (Surrey, England), and CALSOL 5550 naphthenic oil from Calumet Specialty Products Partners, LP (Indianapolis, Ind.).

The hot melt composition can include at least 5% by weight, at least 10% by weight, no greater than 20% by weight, no greater than 10% by weight, from 5% by weight to 20% by weight, or even from 5% by weight to 10% by weight liquid plasticizer.

Tackifying Agent

The hot melt composition can optionally include a limited amount of tackifying agent.

The tackifying agent can function to tackify the mid-block of the SBC or to reinforce the end block of the SBC. The tackifying agent can be fluid or solid at room temperature. Suitable classes of tackifying agents include, e.g., aromatic, aliphatic and cycloaliphatic hydrocarbon resins, mixed aromatic and aliphatic modified hydrocarbon resins, aromatic modified aliphatic hydrocarbon resins, and hydrogenated versions thereof; terpenes, modified terpenes and hydrogenated versions thereof; natural rosins, modified rosins, rosin esters, and hydrogenated versions thereof; low molecular weight polylactic acid; and combinations thereof. Examples of useful natural and modified rosins include gum rosin, wood rosin, tall oil rosin, distilled rosin, hydrogenated rosin, dimerized rosin and polymerized rosin. Examples of useful rosin esters include e.g., glycerol esters of pale wood rosin, glycerol esters of hydrogenated rosin, glycerol esters of polymerized rosin, pentaerythritol esters of natural and modified rosins including pentaerythritol esters of pale wood rosin, pentaerythritol esters of hydrogenated rosin, pentaerythritol esters of tall oil rosin, and phenolic-modified pentaerythritol esters of rosin.

Useful tackifying agents are commercially available under a variety of trade designations including, e.g., hydrocarbon tackifying resins, from Exxon Mobil Chemical Company (Houston, Tex.) including ESCOREZ 5400 (1% aromatic content), ESCOREZ 5415, ESCOREZ 5600 (9.8% aromatic content), ESCOREZ 5690 (10% aromatic content), ESCOREZ 5615 (9.9% aromatic content) and ECR-840, hydrocarbon tackifying resins under the EASTOTAC series of trade designations, from Eastman Chemical (Kingsport, Tenn.) including EASTOTAC H-100R and EASTOTAC H-100L, hydrocarbon C-5 derived tackifying resins under the WINGTACK series of trade designations, hydrocarbon C-5 derived tackifying resins from Cray Valley HSC (Exton, Pa.) including WINGTACK 86, WINGTACK EXTRA, and WINGTACK 95 and hydrocarbon C-5 derived tackifying resin, under the PICCOTAC trade designation included, e.g. PICCOTAC 8095 and pure monomer aromatic tackifying resins under the KRISTALEX and PLASTOLYN series of trade designations from Eastman Chemical Company (Kingsport, Tenn.) including, e.g., KRISTALEX 3100, PLASTOLYN 240 and PLASTOLYN 290.

The hot melt composition can include at least one tackifying agent with aromatic content. The tackifying agent can have an aromatic content of greater than 5%, greater than 20%, greater than 50%, from about 5% to about 20% by weight, from about 7.5% to about 15% by weight, or even from 5% by weight to less than 10% by weight. The aromatic content is measured by Nuclear Magnetic Resonance (NMR) spectroscopy.

The hot melt composition can include a tackifying agent with a softening point of less than 100° C., or even less than 95° C. The hot melt composition can include a tackifying agent with an aromatic content of greater than 50% by weight, having a softening point of greater than about 100° C., greater than about 120° C., or even from about 105° C. to about 160° C.

The hot melt composition can include at least 5% by weight, at least 10% by weight, no greater than 40% by weight, no greater than 30% by weight, no greater than 20% by weight, no greater than 15% by weight, no greater than 30% by weight, from 0% by weight to 40% by weight, from 0% by weight to 30% by weight, from 5% by weight to 40% by weight, from 5% by weight to 30% by weight, from 5% by weight to 25% by weight, from 5% by weight to 15% by weight, or even from 5% by weight to 10% by weight tackifying agent.

Additional Components

The hot melt composition optionally includes additional components including, e.g., stabilizers, antioxidants, additional polymers (e.g. single site e.g. metallocene catalyzed polymers), ethylene based olefin polymers, butene based olefin polymers, etc.), additional waxes (e.g. polyethylene (e.g. EPOLENE N-21 available from Westlake Polymers LLC (Houston, Tex.)) and polypropylene waxes), adhesion promoters, coatings, anti-tack additives, ultraviolet light stabilizers, corrosion inhibitors, colorants (e.g., pigments and dyes), fillers, surfactants, wetness indicators, superabsorbents and combinations thereof.

Useful antioxidants include, e.g., pentaerythritol tetrakis[3,(3,5-di-tert-butyl-4-hydroxyphenyl)propionate], 2,2′-methylene bis(4-methyl-6-tert-butylphenol), phosphites including, e.g., tris-(p-nonylphenyl)-phosphite (TNPP) and bis(2,4-di-tert-butylphenyl)4,4′-diphenylene-diphosphonite, di-stearyl-3,3′-thiodipropionate (DSTDP), and combinations thereof. Useful antioxidants are commercially available under a variety of trade designations including, e.g., the IRGANOX series of trade designations including, e.g., IRGANOX 1010, IRGANOX 565, and IRGANOX 1076 hindered phenolic antioxidants and IRGAFOS 168 phosphite antioxidant, all of which are available from BASF Corporation (Florham Park, N.J.), and ETHYL 702 4,4′-methylene bis(2,6-di-tert-butylphenol). When present, the composition preferably includes from about 0.1% by weight to about 2% by weight antioxidant.

### Disposable Absorbent Article

The hot melt composition can be incorporated in or adhered to a variety of substrates within the disposable absorbent article including, e.g., films (e.g., polyolefin (e.g., polyethylene and polypropylene) films), porous substrates, cellulose substrates, sheets (e.g., paper, and fiber sheets), paper products, woven and nonwoven webs, fibers (e.g., synthetic polymer fibers and cellulose fibers), elastics and tape backings.

The hot melt composition is also useful in a variety of applications and constructions including, e.g., disposable absorbent articles including, e.g., disposable diapers, adult incontinence products, sanitary napkins, medical dressings (e.g., wound care products), bandages, surgical pads, pet training pads (e.g. puppy pads) and meat-packing products, and components of absorbent articles including, e.g., an absorbent element, absorbent cores, impermeable layers (e.g., backsheets), tissue (e.g., wrapping tissue), acquisition layers and woven and nonwoven web layers (e.g., top sheets, absorbent tissue).

The hot melt composition is useful on substrates made from a variety of fibers including, fluff (e.g., natural cellulose fibers such as wood pulp, cotton, silk and wool); synthetic fibers such as nylon, rayon, polyesters, acrylics, polypropylenes, polyethylene, polyvinyl chloride, polyurethane, and glass; recycled fibers, and various combinations thereof.

Various application techniques can be used to apply the hot melt composition to a substrate including, e.g., slot coating, spraying including, e.g., spiral spraying and random spraying, screen printing, foaming, engraved roller, extrusion and meltblown application techniques.

Applications within a Disposable Absorbent Article

Core Stabilization

The hot melt compositions of this invention can be used to contain, immobilize and/or provide strength to the absorbent core of a disposable absorbent article (i.e. core stabilization).

The absorbent core includes the core and optionally a core wrap. The absorbent core can be manufactured in-line (i.e. in the disposable absorbent article) assembly line. Alternatively, the core can be manufactured off-line and then rolled up or festooned for use at a later date or a different location.

The core can vary in design, shape, and in the materials used. It can be shaped like a long rectangle or like a dog bone. It can be one continuous shape or can be broken into channels formed by for example the top sheet and the back sheet.

The core is generally centered within the article, and is firmly secured between the top sheet and back sheet through an attachment means (e.g. an adhesive).

The core includes absorbent materials capable of absorbing bodily fluids and solids received through the top sheet. The core can include cellulose fibers (i.e. fluff), wood pulp, cotton, synthetic fibers, nonwoven, tissue, foam, superabsorbent polymers (e.g.polyacrylates) or any other absorbent material.

The hot melt composition can be applied in a layer as a fiberized web. The web can be achieved by spiral spraying, random spraying (e.g. SIGNATURE spraying using a SIGNATURE nozzle available from Nordson Corporation (Westlake, Ohio)) and omega pattern spraying using an OMEGA nozzle available from ITW Dynatec (Hendersonville, Tenn.), etc. Alternatively, the hot melt composition can be present as a coating (e.g. full slot, pattern slot, etc.).

The absorbent core can comprise less than 10% by weight fluff, or even be entirely fluff free. In a low fluff or fluff free core, the absorbent core comprises the hot melt composition and superabsorbent polymer and optionally layers of nonwoven and/or tissue.

The core can be a composite core. A composite core can comprise less than 10% by weight fluff, or even be entirely fluff free. A composite core includes more than one layer of SAP alternating with layers of nonwoven or tissue and the hot melt composition. The composite core can include from 1 to 5, or even from 2 to 4 individual layers of SAP, alternating with hot melt composition and nonwoven or tissue.

The nonwoven can be a high loft or relatively fluffy nonwoven e.g. SSS nonwoven. SSS nonwoven includes three layers of spun bond nonwoven, it is especially soft and can improve the softness of the core. The nonwoven can comprise polypropylene fibers and is preferably hydrophilic to improved absorption into the core.

The nonwoven can have a relatively high basis weight. The nonwoven can have a basis weight of from 5 grams per square meter (gsm) to 40 gsm, 7 gsm to 30 gsm or even from 10 gsm to 25 gsm.

The hot melt composition can be applied to the first substrate (e.g. first nonwoven), the super absorbent polymer applied to a second substrate (e.g. second nonwoven), and then the substrates mated, such that the super absorbent polymer and hot melt composition are facing each other, to form a layer of the absorbent core.

Alternatively, the hot melt composition can be applied to the first substrate (e.g. a first nonwoven), the superabsorbent polymer applied directly on top of the hot melt composition prior to mating with a second substrate (e.g. second nonwoven).

Alternatively, the superabsorbent can be applied to the first substrate (e.g. a first nonwoven), the hot melt composition applied directly on top of the superabsorbent prior to mating with a second substrate (e.g. second nonwoven).

The second substrate can optionally include hot melt composition and superabsorbent polymer, applied prior to bringing the two substrates together. The two substrates can be mated such that the coated sides face each other.

Additional layers of the absorbent core can be formed by additional layers of super absorbent polymer, hot melt composition and substrates (e.g. nonwoven, tissue, etc.). The order and number of additional layers is not particularly limited.

The core wrap can be any material that wraps around the core to hold the components of the core in place. The core wrap generally wraps around the two longer sides of the core, leaving the ends open. The core wrap can be selected from the group consisting of nonwoven and tissue.

The hot melt composition can be used to hold the absorbent materials in place in both the dry (unexpanded state) and wet (swollen state).

The absorbent core can be used in a variety of disposable absorbent articles including, e.g., disposable diapers, adult incontinence products, sanitary napkins, medical dressings (e.g., wound care products), bandages, surgical pads, pet training pads (e.g. puppy pads) and meat-packing products.

Elastic Composite

The hot melt composition can be used to form an elastic composite and provide stretch to the disposable absorbent article.

The elastic composite can include a first substrate and the hot melt composition. The hot melt composition can be layered on top of the first substrate to impart elasticity to the first substrate. The term “layered on top” includes any level of penetration into the first substrate. In some cases, it may be desirable to have the thermoplastic film penetrate into the substrate. In other cases, it may be desirable to have the thermoplastic film penetrate only very slightly or not at all into the substrate.

The hot melt composition can be adhered to the substrate using techniques known in the art, e.g. by applying heat, by ultrasonic bonding, by a separate adhesive (e.g. hot melt adhesive), etc. Alternatively, the hot melt composition can be applied in a molten state, adhering to the substrate as it is applied.

The elastic composite can include a first substrate, a second substrate and the hot melt composition. The hot melt composition is present between the first and second substrate, providing elasticity to the composite. At least one of the substrates is selected from the group consisting of nonwoven, polymer film and texiles (i.e. fabric formed by weaving (e.g. woven fabric (e.g. cotton, canvas, etc.), knitting, crotcheting, knotting or felting).

Construction

The hot melt composition can further be used for construction applications. In a typical construction application in the manufacture of a disposable absorbent article, a body fluid impermeable backsheet is bonded to a nonwoven substrate. In other construction applications, a nonwoven substrate is bonded to a nonwoven substrate. The hot melt composition may also be used to bond at least one additional layer or material selected from the group consisting of absorbents, tissues, elastomeric materials, superabsorbent polymers, and combinations thereof. For example, the hot melt composition can further be used for back sheet lamination i.e. where the body fluid impermeable backsheet typically a polyolefin film (e.g. polyethylene, polypropylene, ethylene vinyl acetate, ethylene copolymer, etc.) is bonded to a second nonwoven to improve the feel of the disposable article.

The invention will now be described by way of the following non-limiting examples. All parts, ratios, percents and amounts stated in the Examples are by weight unless otherwise specified.

### Examples

### Test Procedures

Test procedures used in the examples and throughout the specification, unless stated otherwise, include the following.

### Hot Melt Composition Preparation

The hot melt samples were prepared in a sigma blade mixer with a batch size of 5000 grams (g). A heating oil temperature of around 177° C. was used. The polymers and additives were added first, blended until smooth and then the wax was added in portions. The mixture was allowed to mix until homogeneous and then dumped. Each sample took about 1 hour to make.

### Viscosity Test Method

Viscosity was determined in accordance with ASTM D-3236 entitled, “Standard Test Method for Apparent viscosity of Adhesives and Coating Materials,” (Oct. 31, 1988), using a Brookfield Thermosel viscometer Model RVDV 2 and a number 27 spindle. The results are reported in centipoise (cP).

### Tensile Elongation and Maximum Stress Test Method

Dumbbell shaped specimen of each hot melt composition 0.127-0.305 centimeters (cm) (0.05-0.12 inch) thickness, 2.54 cm (1 inch) gauge length, 0.318 cm (0.125 inch) gauge width) were cut with a die from a thin film of sample prepared by compression of the sample molten at 176.7° C. (350° F.) with weight greater than 5 kilogram (kg) and cooling to room temperature.

The specimen were allowed to age for 1 day at room temperature prior to being tested. An Instron 5542 benchtop unit equipped with 4.99 kilogram-force (kgf) (11 pound-force (lbf)) load cell was used to determine the tensile properties at room temperature. The crosshead speed was set at 30.48 cm/minute (12 inch/min). At least three dumbbells of each sample were tested. The tensile force and the crosshead displacement were recorded and terminated either upon sample failure or instrument limit was reached 25.4 cm (10 inch) crosshead displacement. The ultimate elongation was calculated by taking the crosshead displacement over the initial sample gauge length and the maximum tensile stress was recorded. Both values were averaged among the specimens tested.

### Peel Test Sample Preparation Method

A comb patterned slot coating applicator, which was 7.62 cm (3 inch) wide, and a laminator were set to an application temperature of 154° C., a nip pressure of 103.4 kilopascal (15 psi), an application weight of 25 g/m2, and minimal rewind and unwind tensions was used so as not to stretch the film. The hot melt adhesive composition was applied continuously at a coat weight of 25 g/m2 on Nonwoven 1 having a basis weight of 8 g/m2 as the web is passed through the applicator at a speed of from 173.7 meters per minute (m/min) to 192.0 m/min. Nonwoven 2 having a basis weight of 10 g/m2, traveling at the same speed as the Nonwoven 1 web, is then nipped into place against the adhesive composition and the Nonwoven 1 web to form a laminate. The laminate is then cut as strips of 5.1 cm (2 inch) in width, along the cross direction (CD) perpendicular to the machine direction of the coater.

### Dynamic Peel Test Method

Dynamic Peel was determined according to ASTM D1876-01 entitled, “Test Method for Determining Peel Resistance of Adhesive (T-Peel Test Method),” with the exception that the test was run at 30.5 centimeters per minute (12 inches per minute) over a period of 10 seconds and 4 replicates were run. The samples were run on an IMASS Spec-type test instrument. Unless otherwise specified, the test samples were prepared as described in the Sample Preparation test method. The samples were peeled along the cross machine coating direction. The average peel value over 10 seconds of peeling was recorded, and the results are reported in grams force per inch (gf/in). The initial Dynamic Peel value is the value measured 24 hours after the sample is prepared. Four replicates were tested and the average value was reported in units of grams of force per inch (gf/in).

### Substrates

Nonwoven 1 (basis weight=8 grams per square meter (gsm), width=165) available from Avgol Ltd. (Mocksville, N.C.).

Nonwoven 2 (basis weight=10 gsm, width=130) available from Avgol Ltd. (Mocksville, N.C.).

TABLE 1

| | | | Melt Flow Rate | |
|---|---|---|---|---|
| | | Polystyrene | (230° C., 2.16 kg, | |
| | Polymer | content | unless otherwise | |
| | type | (weight %) | noted) | |
| KRATON G 1657 | SEBS | 13 | 22 | (230° C., 5 kg) |
| KRATON G 1643 | SEBS | 18 | 18 | |
| KRATON MD1648 | SEBS | 20 | 220 | |
| KRATON MD6951 | SEBSS | 34 | 42 | |
| SOL T H2311 | SEBS | 30 | 2 | |
| VECTOR 4111A | SIS | 18 | 12 | (200° C., 5 kg) |
| TSRC DPX-660 | SIS | 30 | 38 | (190° C., 2.16kg) |

TABLE 2

| | Example 1 | Example 2 | Example 3 | Example 4 | Example 5 |
|---|---|---|---|---|---|
| KRATON MD-1648 | | 63.5 | 64.4 | 55 | 47.5 |
| TSRC DPX-660 | 49 | | | | |
| REXTAC 2730 | | | | 15 | 30 |
| FR-6513 | 49 | 16 | 34.6 | 29 | 22 |
| C-80 | | 20 | | | |
| IRGANOX 1010 | 1.0 | 0.5 | 1.0 | 1.0 | 0.5 |
| Average Dynamic Peel | <10 | <10 | Not tested | 61.1 | 132.7 |
| (grams force/inch) | | | | | |
| Elongation (%) | >1000 | 716 | 835 | 616 | 654 |
| Maximum tensile | 2.99 | 2.64 | 3.82 | 2.28 | 2.17 |
| stress (MPa) | | | | | |
| Brookfield Viscosity @ | 14,300 | 7,800 | 7,350 | 8,350 | 13,000 |
| 162.8° C. | | | | | |
| (325° F.)- cP | | | | | |
| Brookfield Viscosity @ | 3,375 | Not tested | 3,975 | 4,150 | 6,400 |
| 176.7° C. | | | | | |
| (350° F.) - cP | | | | | |

TABLE 3

| | Example 6 | Example 7 | Example 8 | Example 9 |
|---|---|---|---|---|
| KRATON G-1643 | 40 | | | |
| KRATON MD6951 | | 40 | | |
| KRATON G-1657 | | | 34.3 | 30.8 |
| REXTAC 2730 | | | | |
| REXTAC 2715 | | | 11.4 | 20.5 |
| FR-6513 | 59 | 59 | 53.5 | 47.9 |
| IRGANOX 1010 | 1 | 1 | 0.8 | 0.8 |
| Average Dynamic Peel | Not tested | Not tested | 35.8 | 49.3 |
| (grams force/inch) | | | | |
| Elongation (%) | 986 | >1000 | 782 | 720 |
| Maximum tensile | 3.44 | 4.62 | 3.10 | 2.54 |
| stress (MPa) | | | | |
| Brookfield Viscosity @ | 975 | 1680 | 9400 | 8250 |
| 162.8° C. (325° F.)- cP | | | | |

TABLE 4

| | Example 10 | Example 11 | Example 12 | Example 13 | Example 14 | Example 15 |
|---|---|---|---|---|---|---|
| KRATON MD-6951 | 34 | 34 | 34 | | | |
| VECTOR 4111A | | | | 27 | 30 | 30 |
| ECR-840 | 20 | 20 | 15 | | 25 | 10 |
| REXTAC 2715 | 10 | 10 | 15 | | | |
| PARVAN 1580 | | 35 | 35.5 | | | |
| FR-6513 | 35 | | | 67 | 42 | 57 |
| EPOLENE N-21 | | | | 5 | 2 | 2 |
| IRGANOX 1010 | 1 | 1 | 0.5 | 1.0 | 1.0 | 1.0 |
| Average Dynamic Peel | 202* | 161.1* | 93.8* | Not tested | Not tested | Not tested |
| (grams force/inch) | | | | | | |
| *substrate failure | | | | | | |
| Elongation (%) | >1000% | >1000% | >1000% | 1220 | 2110 | 1680 |
| Maximum tensile | 6.78 | 5.94 | 4.99 | 2.69 | 3.86 | 1.35 |
| stress (MPa) | | | | | | |
| Brookfield Viscosity @ | 3900 | 4575 | 6450 | 3775 | 4275 | 3375 |
| 162.8° C. (325° F.)-Cp | | | | | | |
| Brookfield Viscosity @ | Not tested | 7225 | 11030 | Not tested | Not tested | Not tested |
| 148.9° C. (300° F.) -cP | | | | | | |

TABLE 5

| | Example 16 | Example 17 | Comparative 1 | Comparative 2 | Comparative 3 |
|---|---|---|---|---|---|
| KRATON MD-6951 | | 33.3 | 33.3 | 33.3 | |
| KRATON G-1643 | 33.3 | | | | |
| AFFINITY GA-1950 | | | | | 33.3 |
| REXTAC 2730 | 16.7 | 16.7 | 16.7 | 16.7 | 16.7 |
| FR-6513 | 49.2 | 49.2 | | | 49.2 |
| CALSOL 5550 | | | 49.2 | | |
| PURETOL 35 | | | | 49.2 | |
| IRGANOX 1010 | | | 0.8 | 0.8 | 0.8 |
| % Elongation | 692 | >1000 | 690 | 750 | 12 |
| Maximum tensile | 1.78 | 2.65 | 0.41 | 0.47 | 2.54 |
| stress (MPa) | | | | | |
| Brookfield Viscosity @ | 1988 | 4100 | 6475 | 6600 | 710 |
| 162.8° C. (325° F.)- Cp | | | | | |

Other embodiments are within the claims.

What is claimed is:

1. A hot melt composition comprising:
15% by weight to 60% by weight of a styrene block copolymer,
15% by weight to 75% by weight of a wax having a Congealing Point (ASTM D938) of from 45° C. to 90° C., and
no greater than 10% by weight of a liquid plasticizer.

2. The hot melt composition of claim 1 being free of liquid plasticizer.

3. The hot melt composition of claim 1 having a total polymer content of from 15% by weight to 45% by weight.

4. The hot melt composition of claim 1 comprising 25% by weight to 75% by weight of the wax.

5. The hot melt composition of claim 1 further comprising 5% by weight to 40% by weight of a propylene based polymer.

6. The hot melt composition of claim 5 wherein the propylene based polymer has a viscosity at 190° C. by ASTM D3236 of no greater than 7,500 cP and is derived from propylene and at least one monomer selected from the group consisting of hexene, butene, and ethylene.

7. The hot melt composition of claim 1, wherein the wax is a paraffin wax.

8. The hot melt composition of claim 1 wherein the styrene block copolymer has a hydrogenated mid-block.

9. The hot melt composition of claim 1 wherein the styrene block copolymer is a styrene-isoprene-styrene block copolymer.

10. The hot melt composition of claim 1 further comprising from 5% by weight to 40% by weight of a tackifying agent.

11. The hot melt composition of claim 1 being free of a tackifying agent.

12. The hot melt composition of claim 1 wherein the styrene block copolymer has a melt flow index ASTM D1238 (230° C., 2.16 kg) of from 10 to 300.

13. The hot melt composition of claim 1 having an elongation of greater than 800%.

14. The hot melt composition of claim 1 having an elongation of greater than 600% and a maximum tensile stress of at least 1.0 megapascals.

15. A hot melt composition comprising:
from 15% by weight to 45% by weight of a styrene block copolymer,
from 35% by weight to 75% by weight of a wax having a Congealing Point (ASTM D938) of from 45° C. to 90° C., and
optionally up to 40% by weight of a tackifying agent, wherein the hot melt composition is free of plasticizer.

16. An absorbent article comprising:
a hot melt composition; and
a core comprising the hot melt composition and absorbent material;
wherein the hot melt composition secures at least a portion of the absorbent core to a material of the absorbent article; and wherein the hot melt composition comprises:
from 15% by weight to 45% by weight of a styrene block copolymer, and
from 25% by weight to 75% by weight of a wax having a Congealing Point (ASTM D938) of from 45° C. to 90° C.

17. The absorbent article of claim 16 wherein the core comprises less than 10% by weight fluff.

18. The absorbent article of claim 16 having a total polymer content of no greater than 47% by weight.

19. The absorbent article of claim 16 wherein the wax is a paraffin wax.

20. The absorbent article of claim 16 wherein the styrene block copolymer is a styrene-isoprene-styrene block copolymer.
